(19) United States
(12) Patent Application Publication
(10) Pub. No.: US 2017/0127685 A1
(43) Pub. Date: May 11, 2017

(54) REPELLENT ACCESSORIES AGAINST FLEAS, MITES AND INSECTS

(71) Applicant: LOëN HOLDING S.A.R.L., Luxembourg (LU)

(72) Inventor: Lionel Roland Courtot, Perouges (FR)

(21) Appl. No.: 14/983,744

(22) Filed: Dec. 30, 2015

(30) Foreign Application Priority Data
Nov. 5, 2015 (BE) 20155721

(51) Int. Cl. A01N 65/22; A01N 65/12; A01N 25/08; A01N 65/10

(52) U.S. Cl. CPC A01N 65/22; A01N 65/10; A01N 65/12; A01N 25/08

(57) ABSTRACT

Preparation process for repellent materials against fleas, mites and insects, comprising at least two steps, the first step of which is to obtain a basic composition comprising liquid vegetable extracts, water and essential oils, and the second step of which is used to solidify the mixture by adding a solidifying premix comprising alginates, a vegetable gum and optionally solidification retarders such as dry hydrophilic plants, water chelators or other substances, even chemicals. The repellent materials are used as recharges in pockets provided in repellent collars for dogs or cats, horses or other animals, in bracelets for humans, in saddlecloths for horses and are dry and solid materials, which are kept at ambient temperature or in a refrigerator, and are stable over time, without losing the repellent value of the vegetable or natural substances included therein.

### CROSS-REFERENCE TO RELATED APPLICATIONS

This application claims priority of Belgian Patent Application No. 2015/5721 filed Nov. 5, 2015.

### FIELD OF THE INVENTION

The invention concerns repellent accessories to be worn by people or animals against arthropods such as fleas, mites, ticks, and also insects, such as flies and mosquitoes.

More specifically, the purpose of the invention is to provide accessories to be worn by people or animals containing solid charges that release active substances over a period of 3 to 4 weeks, with the charges being made of a repellent material against fleas, mites, ticks or insects but which is of a totally natural origin.

### BACKGROUND OF THE INVENTION

Although repellent materials for flying or crawling insects, and for fleas, mites and ticks are known, these materials are generally not of a completely natural nature but are synthetic chemicals that often harm the environment and are not biodegradable.

Examples of a repellent material of a natural origin are the essential oil of Eucalyptus globulus, peppermint, and the scent of a cut onion.

A material containing such a repellent material can be slid into one or more pockets provided to this end in accessories to be worn such as collars for dogs or cats, halters, saddlecloths and collars for horses, or bracelets for men and women.

### SUMMARY OF THE INVENTION

In the search for a usable process to obtain a repellent material of a completely natural origin, in a form suitable for being slid into pockets of accessories to be worn, the following process has been developed.

In a first step a basic composition is obtained, consisting of:
1—Plant extracts in a liquid form concentrated in active and repellent constituents: between 20 and 70%;
2—Essential oils:
between 1 and 15%;
3—Water:
between 20 and 60%;

Optional:
4—Plant extracts in a powdered form concentrated in active and repellent constituents;
5—Vegetable oils;
6—Marine plasma;
7—Organic silicon (anticaking agent).

In a second step a solidifying premix is added, consisting of:
Alginates (e.g.: brown algae E401) and Calcium (calcium sulphate) with a gelling effect.
Vegetable gum(s) with an emulsifying, binding and thickening effect (examples: Karaya gum, Sterculia, Gum arabic or Acacia senegal gum extract, etc):

Optional:
Natural or chemical substances with a retarding effect (examples: water chelators such as Bambusa bamboo, calcium chelators such as polyphosphates, monosaccharides, etc);
Dry hydrophilic plant (e.g: Plantagoovata);
Other substances, also providing the repellent action of the active substances.

This process has resulted in repellent substances in a solid form, and which remain dry, while the repellent value of the vegetable substances (natural active substances) is preserved thanks to the solidifying premix added at ambient temperature.

An advantage of the process described is that it enables these repellent materials to be preserved in a packaged form without refrigeration, which facilitates transport and the storage of these products for 1 to 7 weeks.

### BRIEF DESCRIPTION OF THE DRAWINGS

For greater clarity, a few example embodiments of repellent materials are given, with reference to the accompanying drawings, wherein:

FIG. 1 schematically shows the steps of the production process of the invention;

FIG. 2 shows a perspective view of a repellent material formed by the process of the invention;

FIG. 3 shows a dog wearing a repellent collar of repellent material according to the invention;

FIG. 4 shows a dog collar, provided with a pocket to contain the repellent material;

FIG. 5 shows a saddlecloth for horses, provided with a pocket for containing the repellent material;

FIG. 6 shows a man wearing a repellent bracelet with repellent material according to the invention.

### DETAILED DESCRIPTION OF THE PREFERRED EMBODIMENTS

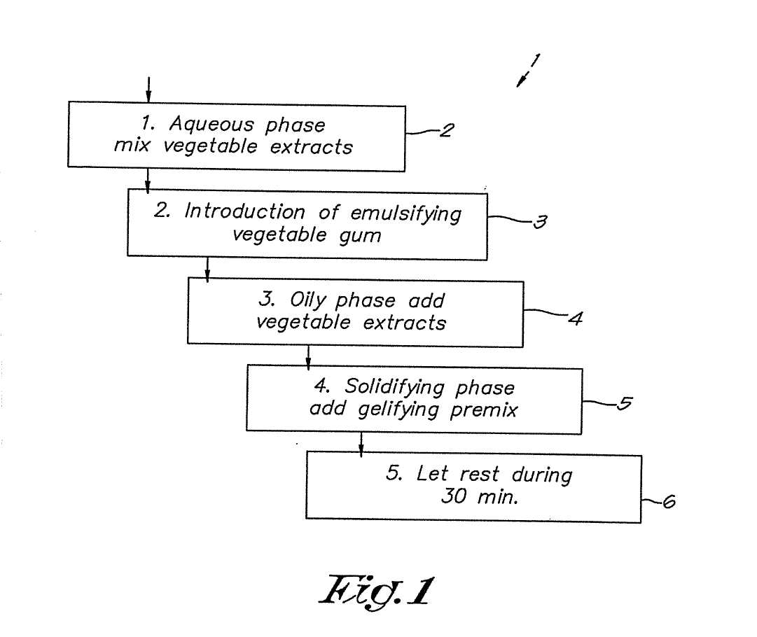

FIG. 1 shows the successive phases of the production process of a repellent material 1 according to the invention, comprising:
1) The aqueous phase 2 in which the vegetable extracts are mixed;
2) The introduction of an emulsifying vegetable gum 3;
3) The oil phase 4 introducing vegetable extracts in the form of oils;
4) The solidification phase 5 with the introduction of the gelling premix, in order to emulsify until a paste is obtained;
5) The rest phase 6 for approximately 30 minutes, to allow the solidifying premix to act until a stable solid is obtained.

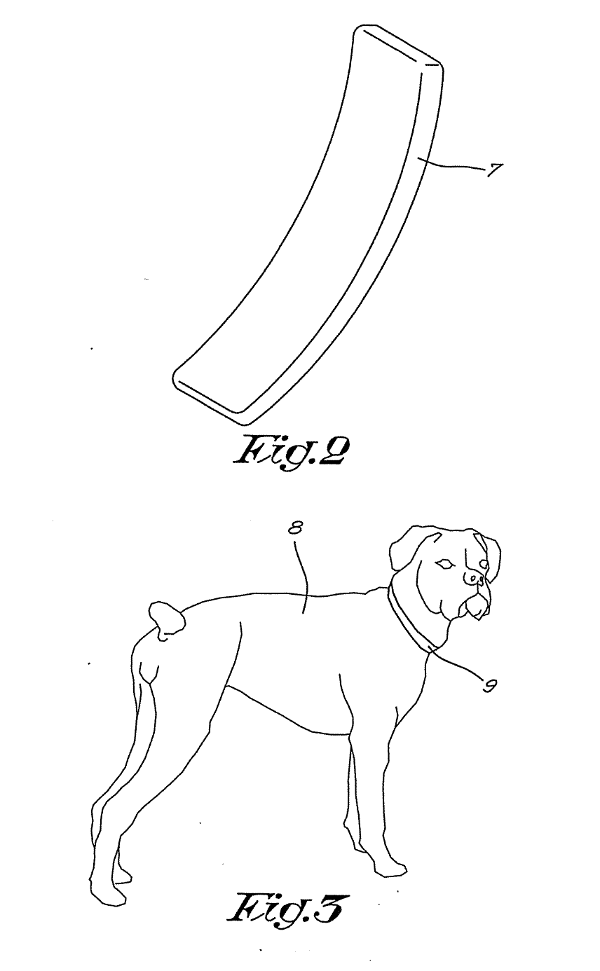

FIG. 2 shows a repellent material 7 formed by the process of the invention, i.e. a solid dry product with a form suitable for being slid into the pockets of accessories to be worn.

FIG. 3 shows a dog 8 wearing a repellent collar 9 containing a repellent material according to the invention.

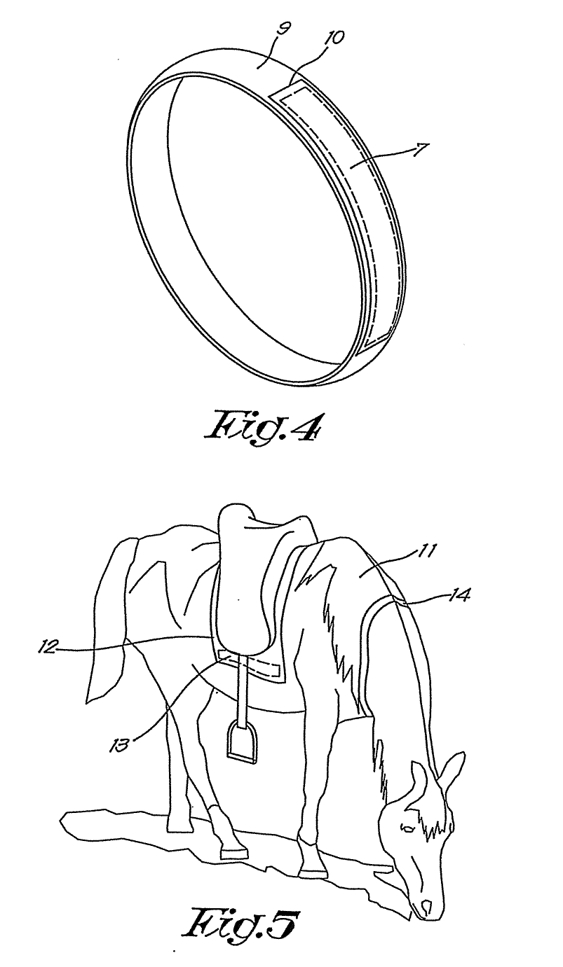

FIG. 4 shows the repellent collar 9 on a larger scale, showing a pocket 10 provided in the collar to be filled with a recharge of repellent material 7 in solid form.

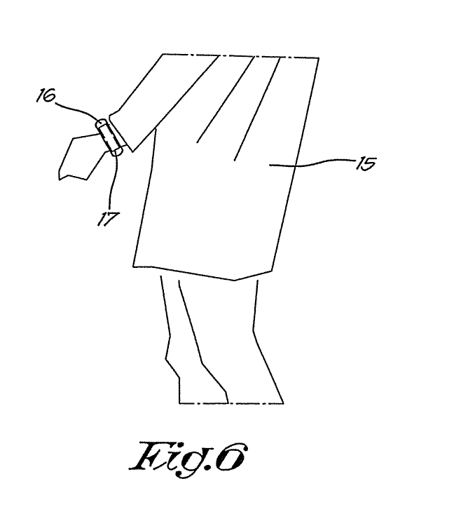

FIG. 5 shows a horse 11 wearing a saddlecloth 12 for horses, provided with a pocket 13 to be filled with a recharge of repellent material, and also wearing a halter 14 of repellent material.

FIG. 6 shows a man 15 wearing a bracelet 16 provided with a recharge 17 of repellent material.

In order to illustrate the production process according to the invention, the application of the process to the production of a repellent material, in particular a product to repel insects, is described as an example hereinafter.
1) Mixing in the aqueous phase:
   Water: 35%
   Marine plasma: 10%
   Colloidal silicon: 5%
   Extract* of peppermint (Menthapiperita): 10%
   Extract* of ground elder (Aegopodiumpodagraria): 15%
   Extract* of mugwort (Artemisia vulgaris): 10%
   *: hydroalcoholic glycerine extracts or hydroalcoholic extracts.
2) Introduction of the gum arabic and emulsification:
   Gum arabic: 1%
3) Continuation of the emulsification of the oil phase by introducing:
   Eucalyptus essential oil (Eucalyptus globulus): 2%
   Basil essential oil (Ocimumgratissimum): 1%
   Peppermint essential oil (Menthapiperita): 1%
4) In the solidification phase, introduction of the gelling premix and the powdered plants prepared beforehand, then mixing.
   Powdered pyrethrin: 2%
   Sodium alginate: 7.8%
   Calcium sulphate: 0.1%
   Xanthan gum: 0.1%

It is clear that the invention is by no means limited to the examples described above, but that many modifications can be made to the form and composition of repellent materials while respecting the production process described above without departing from the scope of the invention as defined in the following claims.

1. Preparation process for repellent materials, characterised in that it comprises at least the following steps:
In a first step a basic composition is obtained, consisting of:
1—Plant extracts in a liquid form concentrated in active and repellent constituents:
between 20 and 70%;
2—Essential oils:
between 1 and 15%;
3—Water:
between 20 and 60%.
In a second step a solidifying premix is added, consisting of:
Alginates (e.g.: brown algae E401) and Calcium (calcium sulphate) with a gelling effect.
Vegetable gum(s) with an emulsifying, binding and thickening effect (examples: Karaya gum, Sterculia, Gum arabic or Acacia senegal gum extract, etc).

2. Repellent material, obtained by the process of claim 1, characterised in that the repellent material has the form of a solid body, of a size suitable for being introduced as a recharge into pockets or spaces provided in accessories to be worn by humans or animals, such as collars, buckles, saddlecloths for horses, bracelets.

3. Use of the repellent material, obtained by the process of claim 1, for external human or animal use.

4. Use of the repellent material according to claim 3, such as a solid recharge of repellent material for arthropods, to be introduced into accessories to be worn by people or animals.

5. Use of the repellent material according to claim 3, such as a solid recharge containing a natural repellent material for insects, to be introduced into accessories to be worn by people or animals.

6. Use of the repellent material according to claim 4, characterised in that the accessories to be worn are collars for dogs or cats, halters, collars and saddlecloths for horses, or collars or bracelets for men and women.

7. Preparation process for repellent materials, characterised in that it comprises at least the following steps:
In a first step a basic composition is obtained, consisting of:
1—Plant extracts in a powdered form concentrated in active and repellent constituents;
2—Vegetable oils;
3—Marine plasma;
4—Organic silicon (anticaking agent).
In a second step a solidifying premix is added, consisting of:
Alginates (e.g.: brown algae E401) and Calcium (calcium sulphate) with a gelling effect.
Vegetable gum(s) with an emulsifying, binding and thickening effect (examples: Karaya gum, Sterculia, Gum arabic or Acacia senegal gum extract, etc).

8. Preparation process for repellent materials, characterised in that it comprises at least the following steps:
In a first step a basic composition is obtained, consisting of:
1—Plant extracts in a liquid form concentrated in active and repellent constituents:
between 20 and 70%;
2—Essential oils:
between 1 and 15%;
3—Water:
between 20 and 60%.
In a second step a solidifying premix is added, consisting of:
Natural or chemical substances with a retarding effect (examples: water chelators such as Bambusa bamboo, calcium chelators such as polyphosphates, monosaccharides, etc);
Dry hydrophilic plant (e.g: Plantagoovata);
Other substances, also providing the repellent action of the active substances.
